(19) United States
(12) Patent Application Publication
(10) Pub. No.: US 2008/0068797 A1
(43) Pub. Date: Mar. 20, 2008

(54) Mounting assembly and electronic device with the mounting assembly

(76) Inventor: Takashi Iikubo, Ome-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/799,434

(22) Filed: May 1, 2007

(30) Foreign Application Priority Data
Sep. 15, 2006 (JP) 2006-251606

(51) Int. Cl. H05K 7/20

(52) U.S. Cl. 361/695; 361/709

(57) ABSTRACT

According to one embodiment, a mounting assembly according to the invention comprises a substrate, a first heat sink, a coupling mechanism, a first heat emitter, a second heat emitter, first thermally conductive grease, second thermally conductive grease, and a second heat sink. The first heat emitter and the second heat emitter are mounted on the substrate between the substrate and the first heat sink. The first thermally conductive grease thermally couples the first heat sink to the first heat emitter. The second thermally conductive grease thermally couples the first heat sink to the second heat emitter. The second heat sink is vertically movable relative to the first heat sink.

### CROSS-REFERENCE TO RELATED APPLICATIONS

This application is based upon and claims the benefit of priority from Japanese Patent Application No. 2006-251606, filed Sep. 15, 2006, the entire contents of which are incorporated herein by reference.

### BACKGROUND

1. Field

One embodiment of the invention relates to a mounting assembly capable of cooling a heat emitter mounted on a substrate, and an electronic device incorporating the mounting assembly.

2. Description of the Related Art

Jpn. Pat. Appln. KOKAI Publication No. 2004-247724, for example, discloses a mounting assembly to cool circuit components. This mounting assembly comprises a substrate, a plurality of circuit components mounted on the substrate, a heat sink covering the upper surfaces of the circuit components so as to be in thermal contact with them, and a thermally conductive material provided below the heat sink around the circuit components. In the mounting assembly, the heat emitted by the circuit components is dissipated to the outside through the heat sink. Further, the heat emitted by the pins of the circuit components is dissipated through the heat sink and thermally conductive material.

Jpn. Pat. Appln. KOKAI Publication No. 2000-332169 discloses another mounting assembly for cooling circuit components. This mounting assembly comprises a substrate, circuit components mounted on the substrate, a heat sink attached to the substrate from above the circuit components, thermally conductive grease interposed between the circuit components and heat sink to thermally couple them, and an elastic member surrounding the thermally conductive grease. The elastic member is formed of a thermally conductive material, and prevents the thermally conductive grease from oozing out when the gap between the substrate and heat sink contracts.

In the invention described in Jpn. Pat. Appln. KOKAI Publication No. 2004-247724, no elastic member is interposed between the heat sink and circuit components, therefore thermal contact therebetween cannot always be maintained. Further, in the invention described in Jpn. Pat. Appln. KOKAI Publication No. 2000-332169, no problem will occur as long as any change in the gap is small. However, if a large change in the gap occurs, and excessive pressure is exerted on the thermally conductive grease and elastic member, the grease may ooze from the contact of the elastic member and circuit components or heat sink.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view illustrating a portable computer according to a first embodiment of the invention;

FIG. 2 is an exemplary sectional view illustrating a mounting assembly received in the housing of the portable computer of FIG. 1;

FIG. 3 is an exemplary perspective view of the mounting assembly shown in FIG. 2;

FIG. 4 is an exemplary exploded perspective view of the mounting assembly shown in FIG. 3;

FIG. 5 is an exemplary sectional view taken along line F5-F5 of FIG. 2;

FIG. 6 is an exemplary partly enlarged sectional view illustrating a first heat emitter incorporated in the mounting assembly of FIG. 5;

FIG. 7 is an exemplary sectional view illustrating a case where the attachment position of the first heat sink is set higher than in the mounting assembly of FIG. 5; and

FIG. 8 is an exemplary sectional view illustrating a mounting assembly incorporated in a portable computer according to a second embodiment of the invention.

### DETAILED DESCRIPTION

Various embodiments according to the invention will be described hereinafter with reference to the accompanying drawings. In general, according to one embodiment of the invention, a mounting assembly comprises a substrate, a first heat sink, a coupling mechanism, a first heat emitter, a second heat emitter, first thermally conductive grease, second thermally conductive grease, and a second heat sink. The first heat emitter and the second heat emitter are mounted on the substrate between the substrate and the first heat sink. The first thermally conductive grease thermally couples the first heat sink to the first heat emitter. The second thermally conductive grease thermally couples the first heat sink to the second heat emitter. The second heat sink is vertically movable relative to the first heat sink.

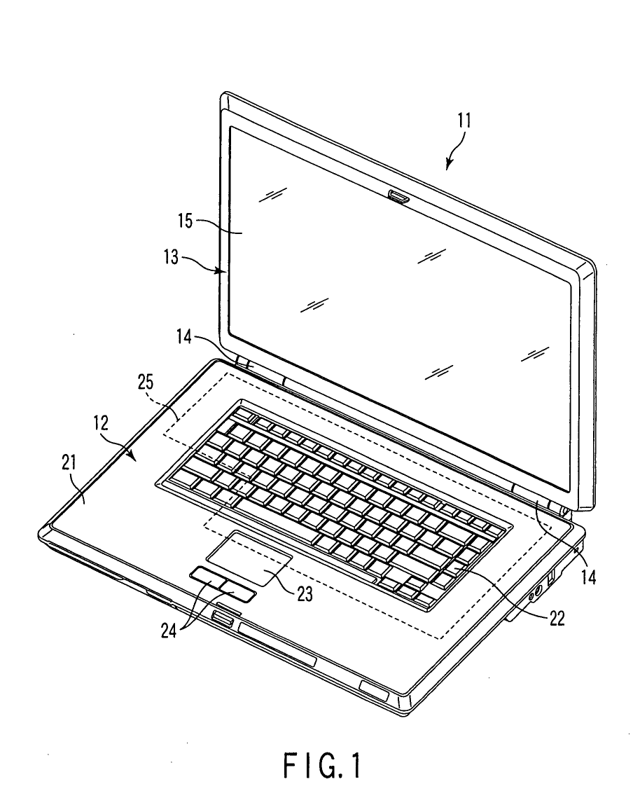

Referring to FIGS. 1 to 7, a description will be given of an electronic device according to a first embodiment, which employs a mounting assembly according to the invention. A portable computer 11 as an electronic device example comprises a main unit 12, display unit 13, and hinges 14 provided between the main unit 12 and display unit 13. The hinges 14 are support the display unit 13 so that the display unit 13 can rotate. The display unit 13 includes a display 15.

The main unit 12 includes a resin housing 21, keyboard 22, touch pad 23 as a pointing device, and button 24.

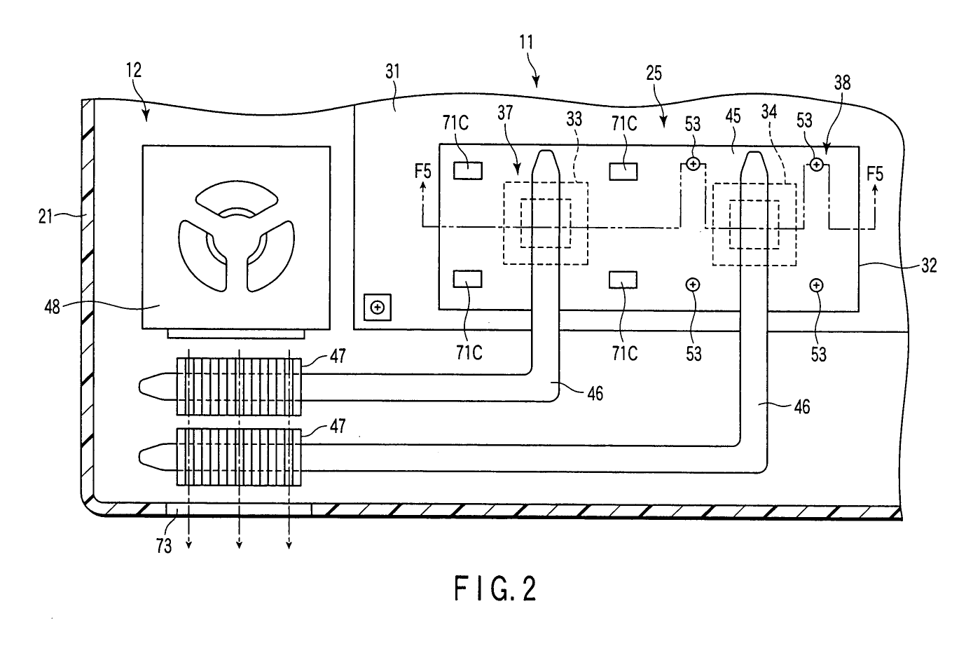

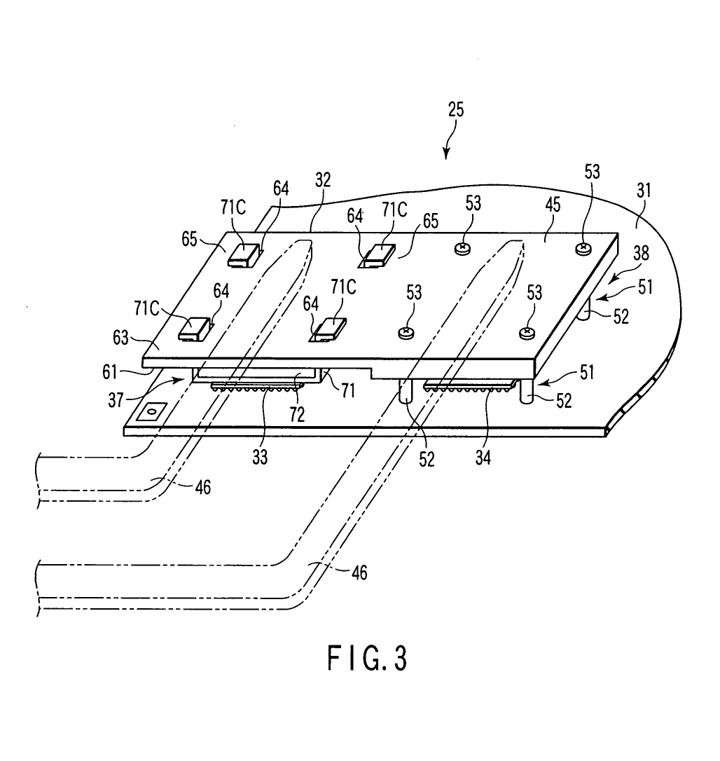

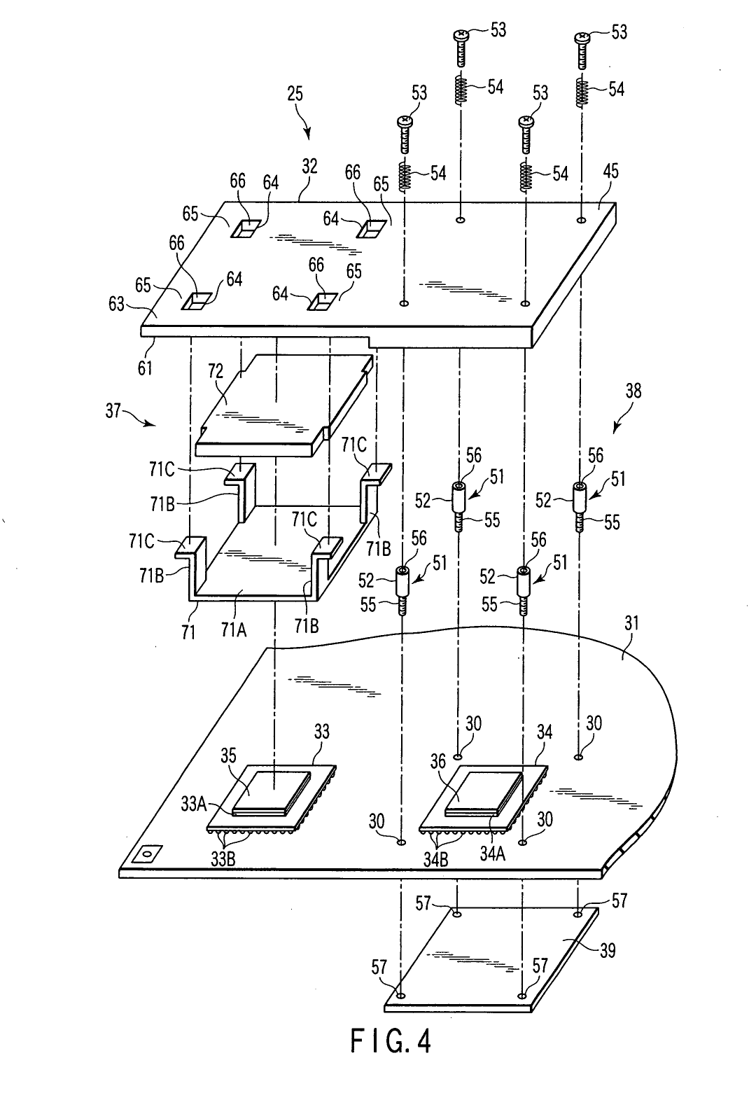

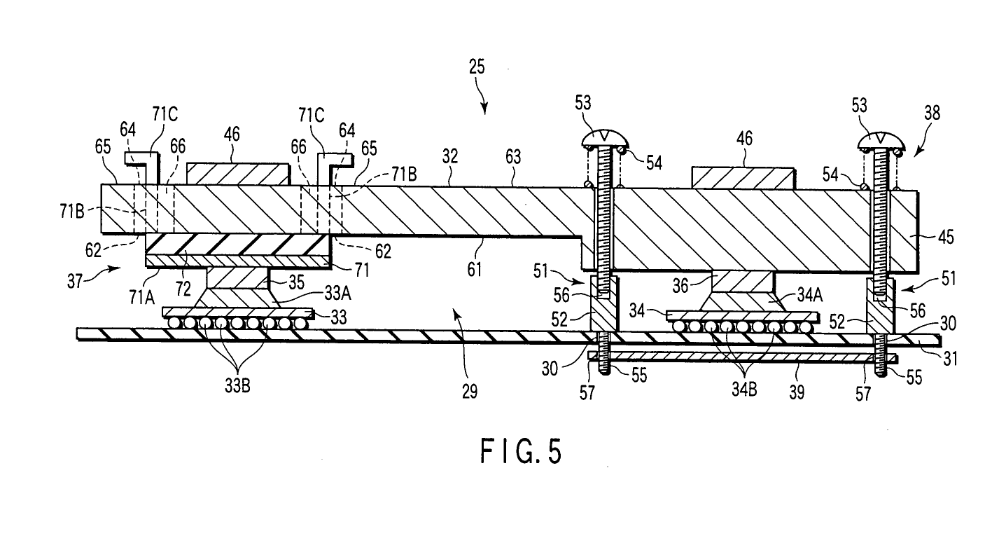

As shown in FIGS. 1 and 2, a mounting assembly 25 is contained in the housing 21. As shown in FIGS. 3 to 5, the mounting assembly 25 includes a substrate 31, first heat sink 32, first heat emitter 33, second heat emitter 34, first thermally conductive grease 35, second thermally conductive grease 36, second heat sink 37, coupling mechanism 38 and back plate 39. The substrate 31 is a printed wiring board formed of wiring layers stacked on each other. As is shown in FIGS. 4 and 5, the substrate 31 has four holes 30 through which male-screw portions 55 of stud main bodies 52 are inserted.

As can be seen from FIG. 5, the first heat emitter 33 is interposed between the substrate 31 and first heat sink 32. As shown in FIG. 4, the first heat emitter 33 is formed of, for example, a semiconductor package in the shape of a ball grid array (BGA), and comprises, for example, a north bridge. The first heat emitter 33 includes a resin mold 33A having a semiconductor element buried therein, and solder balls 33B serving as connection terminals. The second heat emitter 34 is also interposed between the substrate 31 and first heat sink 32. The second heat emitter 34 is, for example, a BGA-type semiconductor package formed of, for example, a graphics chip. The second heat emitter 34 comprises a resin mold 34A having a semiconductor element buried therein, and solder balls 34B serving as connection terminals. The first and second heat emitters 33 and 34 are mainly cooled by the first heat sink 32. In the embodiment, the first and second heat emitters 33 and 34 may not always be formed of a north bridge or graphics chip, but may be formed of another heat emitter such as a CPU.

As shown in FIGS. 3 to 5, the first heat sink 32 opposes the substrate 31 so that at least part of the unit 32 is parallel to the substrate 31. A gap 29 is defined between the first heat sink 32 and substrate 31. Namely, the first heat sink 32 and substrate 31 just oppose each other with the gap 29 interposed therebetween. Further, the first heat sink 32 and substrate 31 oppose each other with the first and second heat emitters 33 and 34 interposed therebetween, as shown in FIG. 5.

As can be understood from FIGS. 2 to 5, the first heat sink 32 comprises a heat sink plate 45 opposing parallel to the substrate 31, two heat pipes 46 thermally coupled to the heat sink plate 45, two radiator fins 47 thermally coupled to the heat pipes 46, and a fan 48 for cooling the radiator fins 47. The heat pipes 46 are formed of, for example, copper. The heat pipes 46 and heat sink plate 45 are fixed by, for example, soldering. The heat emitted by the first and second heat emitters 33 and 34 can be discharged to the outside by the first heat sink 32.

The coupling mechanism 38 couples the substrate 31 to the first heat sink 32 such that they oppose each other. As shown in FIG. 5, the coupling mechanism 38 couples the substrate 31 to the first heat sink 32 such that the size of the gap 29 between the substrate 31 and first heat sink 32 is equal to the sum of the height of the second heat emitter 34 and that of the second thermally conductive grease 36. The coupling mechanism 38 comprises four studs 51 at positions corresponding to the corners of the second heat emitter 34. Thus, the coupling mechanism 38 is provided biasedly around the second heat emitter 34.

The studs 51 connect the substrate 31 to the heat sink plate 45, and each include a stud main body 52 located therebetween, a screw 53 screwed into the stud main body 52 through the heat sink plate 45, and a spring 54 interposed between the heat sink plate 45 and screw 53. The stud main body 52 includes a male screw portion 55 screwed into the back plate 39 through the substrate 31, and a female screw hole 56 engaged with the screw 53. The back plate 39 includes a female screw hole 57 engaged with the male screw portion 55 of the stud main body 52. The heat sink plate 45 is elastically pressed against the second thermally conductive grease 36 and second heat emitter 34 with a preset pressure by the spring 54 of the coupling mechanism 38. The back plate 39 serves as a reinforcing plate for preventing the substrate 31 from being deformed by the pressure of the heat sink plate 45.

The heat sink plate 45 is formed of, for example, an aluminum alloy by aluminum die casting. As shown in FIGS. 2 to 5, the heat sink plate 45 includes a first surface 61, first openings 62, a second surface 63, second openings 64, opening-defining portions 65 for defining the second openings 64, and through holes 66. The first surface 61 opposes a flat plate 71A incorporated in a metal fitting 71, described later, included in the second heat sink 37. The first openings 62 are formed in the first surface 61. The first and second surfaces 61 and 63 are the opposite sides of the heat sink plate 45. The second openings 64 are formed in the second surface 63. The second surface 63 includes the opening-defining portions 65 that define the second openings 64. The through holes 66 make the first openings 62 communicate with the second openings 64. Guide portions 71B, described later, incorporated in the metal fitting 71 are inserted in the through holes 66.

The first thermally conductive grease 35 is, for example, a silicone-oil-based oil compound. As shown in FIG. 5, the first thermally conductive grease 35 is provided on the resin mold 33A of the first heat emitter 33. The first thermally conductive grease 35 is interposed between the first heat emitter 33 and first heat sink 32 and thermally coupled to the first heat emitter 33. The second thermally conductive grease 36 is also formed of, for example, a silicone-oil-based oil compound. As shown in FIG. 5, the second thermally conductive grease 36 is provided on the resin mold 34A of the second heat emitter 34. The second thermally conductive grease 36 is interposed between the second heat emitter 34 and first heat sink 32 and thermally couples them.

The second heat sink 37 is interposed between the first heat sink 32 and first thermally conductive grease 35 and thermally couples them. The second heat sink 37 thermally couples the first heat sink 32 to the first thermally conductive grease 35, and is vertically movable relative to the first heat sink 32.

The second heat sink 37 includes the above-mentioned thermally conductive metal fitting 71 and a thermally conductive sheet 72. The metal fitting 71 is made of a heat diffusive material such as copper. The metal fitting 71 includes the above-mentioned flat plate 71A kept in contact with the first thermally conductive grease 35, and the above-mentioned guide portion 71B extending from the flat plate 71A and engaged with the first heat sink 32. The guide portion 71B extends perpendicular to the flat plate 71A. The guide portion 71B guides vertical movement of the flat plate 71A. The thermally conductive sheet 72 has an area equal to or smaller than that of the flat plate 71A of the metal fitting 71, and is, for example, adhered to the flat plate 71A. The thermally conductive sheet 72 is interposed between the flat plate 71A of the metal fitting 71 and the first heat sink 32. As shown in FIGS. 4 and 5, the flat plate 71A of the metal fitting 71 and the thermally conductive sheet 72 have an area greater than that of the first thermally conductive grease 35.

The thermally conductive sheet 72 is made of, for example, silicone rubber, and has heat conductivity, insulation properties and elasticity. In the mounted state shown in FIG. 5, the fastening force of the screw 53 of the coupling mechanism 38 and the pressing force of the spring 54 compress the thermally conductive sheet 72 by a predetermined thickness. Utilizing the reaction of the compression, the thermally conductive sheet 72 presses the flat plate 71A of the metal fitting 71 against the first thermally conductive grease 35.

The metal fitting 71 includes four hooks 71C at a position corresponding to the corners of the flat plate 71A. The hooks 71C extend in a direction perpendicular to the direction of extension of the guide portions 71B. The hooks 71C are formed to be engaged with the opening-defining portions 65 of the heat sink plate 45. Using the hooks 71C, the metal fitting 71 hangs down from the heat sink plate 45. To engage the metal fitting 71 with the heat sink plate 45, the hooks 71C and guide portions 71B are inserted through the through holes 66 by inwardly warping the guide portions 71B.

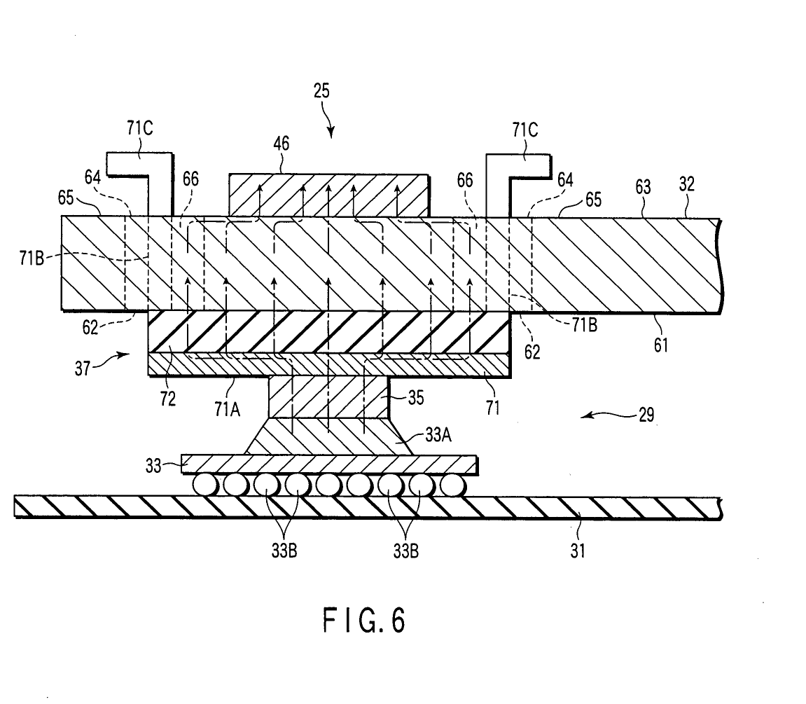

Referring now to FIGS. 2 and 6, a description will be given of the operation of the first heat sink 32 to cool the first heat emitter 33. The heat emitted by the first heat emitter 33 is transmitted to the second heat sink 37 via the first thermally conductive grease 35. This heat is transmitted to the thermally conductive sheet 72 via the metal fitting 71, i.e., the flat plate 71A, of the second heat sink 37, and then to the radiator fins 47 via the heat sink plate 45 and heat pipes 46. The thus-heated radiator fins 47 are cooled by the air supplied through the fan 48, and the resultant heated air is discharged to the outside of the casing 21 through an opening 73 formed in the housing 21.

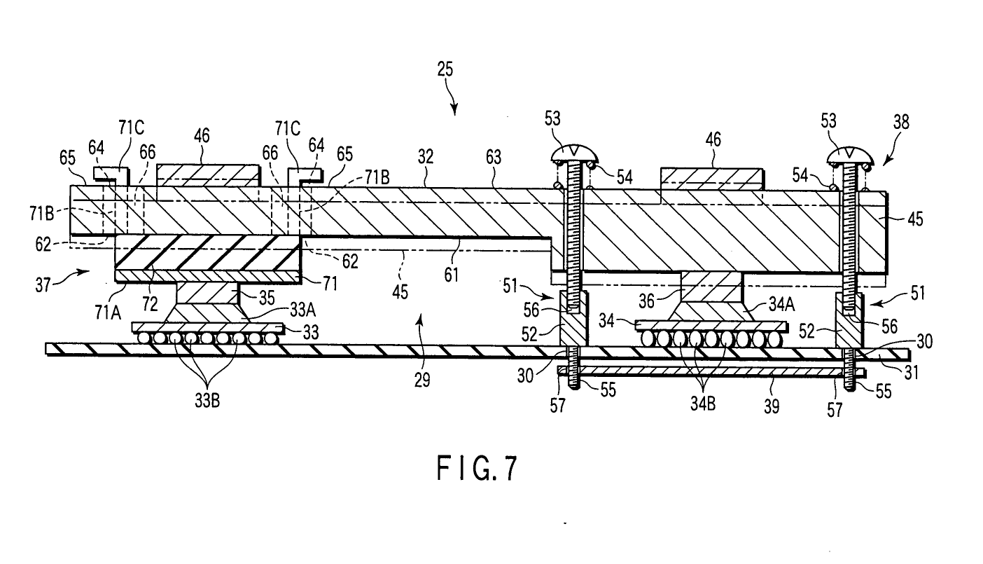

Referring then to FIG. 7, the operation of the second heat sink 37 will be described using, as an example, the case where the height of the second heat emitter 34 is increased. Even when the second heat emitter 34 varies in height, the second heat sink 37 of the embodiment can maintain the thermal coupling between the first heat emitters 33 by absorbing the difference in the height of the heat emitter 34.

The position of the second heat emitter 34 in FIG. 7 is higher than that of the same element in FIG. 5 because of the difference in height between their solder joints using the solder balls 34B. Further, the second thermally conductive grease 36 in FIG. 7 is thicker than that in FIG. 5 due to the difference in application quantity. As a result, the entire height of the first heat sink 32 is greater in FIG. 7 than in FIG. 5. In FIG. 7, the two-dot chain lines indicate the height of the heat sink plate 45 of FIG. 5.

In the vicinity of the first heat emitter 33, the second heat sink 37 can be lowered relative to the first heat sink 32. Namely, when the attachment position of the first heat sink 32 is raised, the thermally conductive sheet 72 of the second heat sink 37 is expanded to thereby press the metal fitting 71 against the first heat emitter 33, although the pressing force of the sheet 72 is slightly reduced compared to that before the expansion. Thus, the second heat sink 37 absorbs the difference in the height of the solder joint of the second heat emitter 34, and the difference in the thickness of the second thermally conductive grease 36. By virtue of the second heat sink 37, the thermal coupling between the first heat emitter 33 and first heat sink 32 can be maintained.

As described above, the mounting assembly 25 of the embodiment comprises the second heat sink 37 that can thermally couple the first heat sink 32 to the first thermally conductive grease 35, and is vertically movable relative to the first heat sink 32. By virtue of this, even when the solder joint of the second heat emitter 34 and/or the second thermally conductive grease 36 varies in height to vary the size of the gap 29 between the substrate 31 and first heat sink 32, the joint between the first heat sink 32 and first heat emitter 33 can absorb the variation. More specifically, even when the gap 29 between the substrate 31 and first heat sink 32 is reduced, a high load is prevented from being exerted on the first thermally conductive grease 35, with the result that the grease is prevented from oozing out. Further, even when the gap 29 is increased, a gap is prevented from occurring between the first thermally conductive grease 35 and first heat sink 32.

As described above, the second heat sink 37 includes the thermally conductive metal fitting 71 having the flat plate 71A and guide portion 71B, and the thermally conductive sheet 72 having elasticity that urges the metal fitting 71 against the first thermally conductive grease 35. Since thus, the second heat sink 37 is formed of the thermally conductive metal fitting 71 and thermally conductive sheet 72, the heat dissipating property of the first heat emitter 33 can be prevented from being reduced even when the second heat sink 37 is employed.

The flat plate 71A and thermally conductive sheet 72 have areas greater than that of the first thermally conductive grease 35. In general, the thermally conductive sheet 72 has a lower heat conductivity than the thermally conductive grease. In this structure, however, the heat emitted by the first heat emitter 33 is diffused and transmitted to a large area of the first heat sink 32 via the flat plate 71A of the metal fitting 71. When the heat is diffused to a large area via the flat plate 71A, the temperature is reduced during heat diffusion. Further, when heat is transmitted through a large area, more efficient heat conduction is realized. As a result, the cooling performance of the first heat sink 32 can be enhanced while allowing a change in the gap 29 between the first heat sink 32 and first heat emitter 33.

As described above, the coupling mechanism 38 is provided biasedly around the second heat emitter 34. Accordingly, the studs 51, for example, of the coupling mechanism 38 are not provided around the first heat emitter 33, with the result that the structure around the first heat emitter 33 can be simplified, and hence the efficiency of use of the space on the substrate 31 can be enhanced. In particular, since it is not necessary to provide holes 30 around the first heat emitter 33, wiring and circuit components can be mounted with high density around the first heat emitter 33.

Further, the coupling mechanism 38 couples the substrate 31 to the first heat sink 32 such that the size of the gap 29 between the substrate 31 and first heat sink 32 is equal to the sum of the height of the second heat emitter 34 and that of the second thermally conductive grease 36. This secures the thermal coupling between the second heat emitter 34 and second thermally conductive grease 36, and that between the second thermally conductive grease 36 and first heat sink 32. On the other hand, near the first heat emitter 33, the second heat sink 37 maintains the thermal coupling between the first heat emitter 33 and first heat sink 32. Namely, not only the thermal coupling between the first heat emitter 33 and first heat sink 32, but also that between the second heat emitter 34 and first heat sink 32 are secured.

The coupling mechanism 38 elastically presses the first heat sink 32 against the second thermally conductive grease 36. This structure can maintain the thermal coupling between the second heat emitter 34 and first heat sink 32 even when the size of the gap 29 between the substrate 31 and first heat sink 32 is varied due to, for example, aging. On the other hand, when the size of the gap 29 is varied for the above-mentioned reason near the first heat emitter 33, the thermally conductive sheet 72 can maintain the thermal coupling between the first heat emitter 33 and first heat sink 32.

Furthermore, in the above-described structure, when an external force is exerted on the portable computer 11, the first heat sink 32 is prevented from being kept pressed against the second thermally conductive grease 36. As a result, the second thermally conductive grease 36 is prevented from receiving a high load and hence from oozing out. On the other hand, around the first heat emitter 33, when a similar external force is exerted, the second heat sink 37 is vertically moved and the thermally conductive sheet 72 absorbs the force. Thus, in the above structure, both the first and second thermally conductive greases 35 and 36 are prevented from receiving a high load, and hence from oozing out.

The hooks 71C of the metal fitting 71 are engaged with the opening-defining portions of the second surface 63. This enables the metal fitting 71 to be formed integral with the heat sink plate 45 of the first heat sink 32. Accordingly, when the first heat sink 32 is mounted on the substrate 31, the heat sink plate 45 and metal fitting 71 can be simultaneously mounted, thereby enhancing the efficiency of mounting.

The first heat sink 32 includes, as well as the heat sink plate 45, the heat pipes 46, radiator fins 47 and fan 48. Therefore, the heat transmitted to the heat sink plate 45 can be discharged to the atmosphere via the heat pipes 46, radiator fins 47 and fan 48. This further enhances the cooling performance of the first heat sink 32.

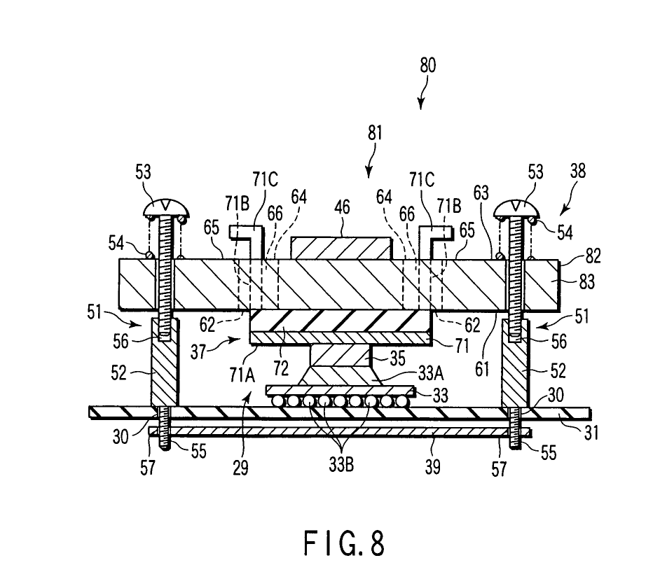

Referring then to FIG. 8, an electronic device according to a second embodiment of the invention will be described. In the second embodiment, a description will be mainly given of elements different from those of the first embodiment. Elements similar to those of the first embodiment are denoted by corresponding reference numbers, and are not described.

A portable computer 80 as an electronic device example according to the second embodiment includes a mounting assembly 81 contained in the housing. Unlike the first embodiment, the mounting assembly 81 includes the first heat emitter 33 but no second heat emitter. Specifically, the mounting assembly 81 includes a substrate 31, first heat sink 82, first heat emitter 33, first thermally conductive grease 35, second heat sink 37, coupling mechanism 38 and back plate 39. The first heat sink 82 opposes the substrate 31 so that at least part of the unit 82 is parallel to the substrate 31. A gap 29 is defined between the first heat sink 82 and substrate 31. Namely, the first heat sink 82 and substrate 31 just oppose each other with the gap 29 interposed therebetween.

The first heat emitter 33 is interposed between the substrate 31 and first heat sink 82. The first heat emitter 33 is formed of, for example, a semiconductor package in the shape of a ball grid array (BGA), and comprises, for example, a north bridge. The first heat emitter 33 may be formed of a graphics chip or CPU.

The first heat sink 82 comprises a heat sink plate 83 opposing the substrate 31, a heat pipe 46 thermally coupled to the heat sink plate 83, a radiator fin (not shown) thermally couple to the heat pipe 46, and a fan (not shown) for cooling the radiator fin.

The coupling mechanism 38 comprises four studs 51 at positions corresponding to the corners of the first heat emitter 33. The studs 51 connect the substrate 31 to the heat sink plate 83, and each include a stud main body 52 located therebetween, a screw 53 screwed into the stud main body 52 through the heat sink plate 83, and a spring 54 interposed between the heat sink plate 83 and screw 53. The stud main body 52 includes a male screw portion 55 screwed into the back plate 39 through the substrate 31, and a female screw hole 56 engaged with the screw 53. The back plate 39 includes a female screw hole 57 engaged with the male screw portion 55 of the stud main body 52. The heat sink plate 83 is elastically pressed against the first and second heat emitters 33 and 34 with a preset pressure by the spring 54 of the coupling mechanism 38.

The second heat sink 37 includes a thermally conductive metal fitting 71 and a thermally conductive sheet 72. The metal fitting 71 includes a flat plate 71A and guide portion 71B. The flat plate 71A and thermally conductive sheet 72 have areas greater than that of the first thermally conductive grease 35.

In the second embodiment, the heat emitted by the first heat emitter 33 is transmitted to the heat pipe 46 and cooling fin via the first thermally conductive grease 35, the flat plate 71A of the metal fitting 71, the thermally conductive sheet 72 and the heat sink plate 83. The cooling fin discharges the heat to the atmosphere.

In the second embodiment, the mounting assembly 81 incorporates the second heat sink 37, which thermally couples the first heat sink 82 to the first thermally conductive grease 35, and is vertically movable relative to the first heat sink 82. Accordingly, even when the gap 29 between the substrate 31 and first heat sink 82 must be adjusted for some reason, the second heat sink 37 can absorb a change in the gap 29 and maintain the thermal coupling between the substrate 31 and first heat sink 82. Further, even when an external force is exerted, the second heat sink 37 absorbs the force, thereby preventing a high load from being exerted on the first thermally conductive grease 35.

Since the second heat sink 37 includes the thermally conductive metal fitting 71 with the flat plate 71A and guide portion 71B, and the thermally conductive sheet 72 having elasticity, reduction of the cooling performance of the first heat emitter 33 can be suppressed even if the second heat sink 37 is employed.

Further, since the flat plate 71A and the thermally conductive sheet 72 have an area greater than that of the first thermally conductive grease 35, a change in the gap 29 between the substrate 31 and first heat sink 82 can be absorbed, and the heat dissipation property of the first heat emitter 33 can be enhanced.

Furthermore, since the metal fitting 71 has hooks 71C to be engaged with the opening-defining portions 65 of the second surface 63, it can be formed integral with the heat sink plate 83 of the first heat sink 82. Therefore, when the first heat sink 82 is mounted on the substrate 31, the heat sink plate 83 and metal fitting 71 can be simultaneously mounted.

The first heat sink 82 includes the heat pipe 46, radiator fin and fan, as well as the heat sink plate 83. This further enhances the cooling efficiency of the first heat emitter 33.

The mounting assemblies 25 and 81 and electronic devices according to the invention are applicable to electronic apparatuses such as portable information terminals, as well as to portable computers.

In the first and second embodiments, the first and second heat emitters 33 and 34 are formed of a BGA-type semiconductor package, they are not limited to this, but may be formed of any other heat-generating component. For instance, one of the first and second heat emitters 33 and 34 may be formed of a Quad Flat Package (QFP) or a coil for use in a power supply circuit. The coil serves to contain current energy in the power supply circuit.

Further, in the first and second embodiments, the heat sinks 32 and 82 of the mounting assemblies 25 and 81 include the heat pipes 46, cooing fins 47 and fans 48, as well as the heat sink plates 45 and 83. However, the cooling fin may be directly attached to the heat sink plate 45 and 83 to enable the heat sink plate 45 and 83 to discharge heat to the atmosphere.

In addition, in the metal fitting 71 employed in each of the first and second embodiments, four guide portions 71B and four hooks 71C are provided at the four corners of the flat plate 71A. Alternatively, two guide portions 71B and two hooks 71C may be provided on corresponding two sides of the flat plate 71A. Further, the structure of the second heat sink 37 is not limited to that employed. It is sufficient if the second heat sink 37 is vertically movable relative respect to the first heat sink 32 or 82. The mounting assemblies and electronic devices of the invention may be modified in various ways, provided that they do not depart from the scope of the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A mounting assembly comprising:
a substrate;
a first heat sink having at least a portion thereof opposing the substrate with a gap interposed therebetween;
a coupling mechanism coupling the substrate to the first heat sink;
a first heat emitter and a second heat emitter mounted on the substrate between the substrate and the first heat sink;
first thermally conductive grease thermally coupling the first heat sink to the first heat emitter;
second thermally conductive grease thermally coupling the first heat sink to the second heat emitter; and
a second heat sink interposed between the first heat sink and the first thermally conductive grease and thermally coupling the first heat sink to the first thermally conductive grease, the second heat sink being vertically movable relative to the first heat sink.

2. The mounting assembly according to claim 1, wherein the second heat sink includes:
a thermally conductive metal fitting provided with a flat plate kept in contact with the first thermally conductive grease, and a guide portion extending from the flat plate and engaged with the first heat sink, the guide portion guiding vertical movement of the flat plate; and
a thermally conductive sheet interposed between the flat plate of the metal fitting and the first heat sink, the thermally conductive sheet having elasticity for pressing the metal fitting against the first thermally conductive grease.

3. The mounting assembly according to claim 2, wherein the flat plate and the thermally conductive sheet have an area greater than an area of the first thermally conductive grease.

4. The mounting assembly according to claim 2, wherein the coupling mechanism is provided biasedly around the second heat emitter.

5. The mounting assembly according to claim 2, wherein the coupling mechanism couples the substrate to the first heat sink to make a size of the gap between the substrate and the first heat sink equal to a sum of a height of the second heat emitter and a height of the second thermally conductive grease.

6. The mounting assembly according to claim 2, wherein the coupling mechanism elastically presses the first heat sink against the second thermally conductive grease.

7. The mounting assembly according to claim 2, wherein:
the first heat sink includes a heat sink plate opposing the substrate, the heat sink plate including a first surface, a second surface opposite to the first surface, and a through hole portion, the first surface opposing the flat plate of the metal fitting and having a first opening portion, the second surface having a second opening portion and a portion defining the second opening portion, the through hole portion connecting the first opening to the second opening portion and permitting the guide portion of the metal fitting to pass therethrough; and
the metal fitting includes a hook extending from the guide portion and engaged with the portion of the second surface.

8. The mounting assembly according to claim 7, wherein the first heat sink further includes:
a heat pipe thermally coupled to the heat sink plate;
a radiator fin thermally coupled to the heat pipe; and
a fan for cooling the radiator fin.

9. An electronic device comprising:
a housing; and
a mounting assembly contained the housing,
the mounting assembly including:
a substrate;
a first heat sink having at least a portion thereof opposing the substrate with a gap interposed therebetween;
a coupling mechanism coupling the substrate to the first heat sink;
a first heat emitter and a second heat emitter mounted on the substrate between the substrate and the first heat sink;
first thermally conductive grease thermally coupling the first heat sink to the first heat emitter;
second thermally conductive grease thermally coupling the first heat sink to the second heat emitter; and
a second heat sink interposed between the first heat sink and the first thermally conductive grease and thermally coupling the first heat sink to the first thermally conductive grease, the second heat sink being vertically movable relative to the first heat sink.

10. The electronic device according to claim 9, wherein the second heat sink includes:
a thermally conductive metal fitting provided with a flat plate kept in contact with the first thermally conductive grease, and a guide portion extending from the flat plate and engaged with the first heat sink, the guide portion guiding vertical movement of the flat plate; and
a thermally conductive sheet interposed between the flat plate of the metal fitting and the first heat sink, the thermally conductive sheet having elasticity for pressing the metal fitting against the first thermally conductive grease.

11. The electronic device according to claim 10, wherein the flat plate and the thermally conductive sheet have an area greater than an area of the first thermally conductive grease.

12. The electronic device according to claim 10, wherein the coupling mechanism is provided biasedly around the second heat emitter.

13. The electronic device according to claim 10, wherein the coupling mechanism couples the substrate to the first heat sink to make a size of the gap between the substrate and the first heat sink equal to a sum of a height of the second heat emitter and a height of the second thermally conductive grease.

14. The electronic device according to claim 10, wherein the coupling mechanism elastically presses the first heat sink against the second thermally conductive grease.

15. The electronic device according to claim 10, wherein:
the first heat sink includes a heat sink plate opposing the substrate, the heat sink plate including a first surface, a second surface opposite to the first surface, and a through hole portion, the first surface opposing the flat plate of the metal fitting and having a first opening portion, the second surface having a second opening portion and a portion defining the second opening portion, the through hole portion connecting the first opening portion to the second opening portion and permitting the guide portion of the metal fitting to pass therethrough; and
the metal fitting includes a hook extending from the guide portion and engaged with the portion of the second surface.

16. The electronic device according to claim 15, wherein the first heat sink further includes:
a heat pipe thermally coupled to the heat sink plate;
a radiator fin thermally coupled to the heat pipe; and
a fan for cooling the radiator fin.

17. A mounting assembly comprising:
a substrate;
a first heat sink having at least a portion thereof opposing the substrate with a gap interposed therebetween;
a coupling mechanism coupling the substrate to the first heat sink;
a heat emitter mounted on the substrate between the substrate and the first heat sink;
thermally conductive grease thermally coupling the first heat sink to the heat emitter;
a second heat sink interposed between the first heat sink and the thermally conductive grease and thermally coupling the first heat sink to the thermally conductive grease, the second heat sink being vertically movable relative to the first heat sink.

18. The mounting assembly according to claim 17, wherein the second heat sink includes:
a thermally conductive metal fitting provided with a flat plate kept in contact with the first thermally conductive grease, and a guide portion extending from the flat plate and engaged with the first heat sink, the guide portion guiding vertical movement of the flat plate; and
a thermally conductive sheet interposed between the flat plate of the metal fitting and the first heat sink, the thermally conductive sheet having elasticity for pressing the metal fitting against the thermally conductive grease.

19. The mounting assembly according to claim 18, wherein the flat plate and the thermally conductive sheet have an area greater than an area of the thermally conductive grease.

20. The mounting assembly according to claim 18, wherein:
the first heat sink includes a heat sink plate opposing the substrate, the heat sink plate including a first surface, a second surface opposite to the first surface, and a through hole portion, the first surface opposing the flat plate of the metal fitting and having a first opening portion, the second surface having a second opening portion and a portion defining the second opening portion, the through hole portion connecting the first opening portion to the second opening portion and permitting the guide portion of the metal fitting to pass therethrough; and
the metal fitting includes a hook extending from the guide portion and engaged with the portion of the second surface.
